(19) United States
(12) Patent Application Publication
(10) Pub. No.: US 2013/0245143 A1
(43) Pub. Date: Sep. 19, 2013

(54) COMPOSITE POLYURETHANE FOAM

(71) Applicant: David S. Soane, Chestnut Hill, MA (US)

(72) Inventor: David S. Soane, Chestnut Hill, MA (US)

(73) Assignee: Soane Labs, LLC, Cambridge, MA (US)

(21) Appl. No.: 13/775,575

(22) Filed: Feb. 25, 2013

Related U.S. Application Data
(63) Continuation of application No. PCT/US11/48919, filed on Aug. 24, 2011.
(60) Provisional application No. 61/376,486, filed on Aug. 24, 2010.

(51) Int. Cl. C08K 9/04

(52) U.S. Cl. CPC C08K 9/04
USPC 521/88; 521/170; 521/94

(57) ABSTRACT

The invention encompasses compositions and methods for the preparation thereof, wherein the composition comprises a polymeric foam that comprise a plurality of polymeric struts having an air-foam interface, wherein a composition comprising inorganic particulate matter is disposed upon the air-foam interface, the inorganic particulate material comprising inorganic particles coated with a hydrophobic amine modifier.

### RELATED APPLICATIONS

This application is a continuation of International Application No. PCT/US11/48919, which designated the United States and was filed on Aug. 24, 2011, published in English, which claims the benefit of U.S. Provisional Application No. 61/376,486 filed Aug. 24, 2010. The entire teachings of the above applications are incorporated herein by reference.

### FIELD OF APPLICATION

This application relates generally to a polyurethane foam composite.

### BACKGROUND

Urethane foams are well-known in the construction industry, for example, as insulation in buildings. Urethane foams are efficient insulators, and are easily applied. Unmodified urethane foams burn easily however, and release toxic fumes. Flame-retardant materials can be added to urethane foams to prevent the ignition of the foam and/or to control the spread of flames along the combustible substrate. These flame-retardant agents can interfere with the handling characteristics of the foam and can themselves contain toxic materials. There remains a need in the art, therefore, for a urethane-based insulation system having the desirable handling characteristics of unmodified urethane foam while resisting combustion and avoiding the dissemination of toxic materials.

Clay has been suggested as an additive for various polymeric foam materials in low concentrations. However, at low concentrations of clay in a polymeric foam (e.g., 20% or less) the majority of the foam matrix is still organic, with the attendant risk of flammability. Low concentrations of clay (e.g., 20% or less) can be seen in preparations where the clay is not fully exfoliated, or where the exfoliated clay is not treated to permit higher inorganic loading. There remains a need in the art, therefore, for compositions and methods that introduce high levels of inorganic loading with polyurethane foam to provide fire retardancy, while retaining the useful properties and characteristics of the foam for various applications.

### SUMMARY OF THE INVENTION

Disclosed herein are compositions comprising a polymeric foam that comprise a plurality of polymeric struts having an air-foam interface, wherein a composition comprising inorganic particulate matter is disposed upon the air-foam interface, the inorganic particulate material comprising inorganic particles coated with a hydrophobic amine modifier. In embodiments, the hydrophobic amine modifier is capable of exhibiting hydrophobic properties during formation of the polymeric foam. In embodiments, the hydrophobic amine modifier comprises a polyamine having an alkyl extension capable of rendering the modifier hydrophobic during formation of the polymeric foam. In embodiments, the hydrophobic amine modifier does not include hydroxyl groups. In embodiments, the polymeric foam comprises closed cells. In embodiments, the polymeric struts comprise a polyurethane polymer. In embodiments, the inorganic particulate matter comprises clay platelets. In embodiments, the inorganic particulate matter comprises greater than 20% by weight of the polymeric foam. Further disclosed herein are articles of manufacture comprising the aforesaid compositions. Also disclosed are polymeric foam precursor compositions comprising an aqueous dispersion of a polymeric foam precursor and inorganic particles coated with a hydrophobic amine modifier.

Also disclosed herein are methods for producing an inorganic-containing polymeric foam, comprising providing inorganic particles coated with a hydrophobic amine modifier, and forming a stable aqueous dispersion of the coated inorganic particles with polymeric foam precursors, thereby producing the inorganic-containing polymeric foam, for example, by initiating polymerization. In embodiments, a polymerization reaction can proceed by using suitable catalysts or initiators mixed with monomers and co-monomer system. Polyurethanes, for example, can be formed by step-growth polymerization mechanism which proceeds by the condensation reaction between the hydroxyl and isocyanate functional groups of the selected monomers. Bifunctional monomers (diisocyanates and polyols), for example, can react with each other under suitable temperature with the help of catalysts from the tertiary amines family of compounds, such as dimethylcyclohexylamine, and organometallic compounds, such as dibutyltin dilaurate or bismuth octanoate. Catalysts can also be chosen to drive the urethane reaction (reaction between isocyanate and hydroxyl) such as TEDA (triethylenediamine) or 1,4-diazabicyclo[2.2.2]octane or drive the foaming reaction (reaction between water and isocyanate) using bis-(2-dimethylaminoethyl)ether.

In embodiments, the inorganic-containing foam comprises greater than about 40% inorganic particles by weight. In embodiments, the method does not include any other coupling agents to bind the inorganic particles to struts of a polymeric foam. In embodiments, the step of forming the stable aqueous dispersion comprises the hydrophobic amine modifier tending to act hydrophobically in the stable aqueous dispersion environment. In embodiments, the hydrophobic amine modifier drives the coated inorganic particles to an air-foam interface during foam formation. In embodiments, the step of forming the stable aqueous dispersion comprises reacting free amines on the coated inorganic particles with at least one polymeric foam precursor. In embodiments, the step of forming the stable aqueous dispersion includes adding alcohol to the dispersion to alter a rate of foam formation.

### DETAILED DESCRIPTION

Polyurethane foam for various applications can be either open cell or closed cell in morphology, or can include a mixture of morphologies. Any of these types of foam has a large interfacial surface area, where the struts of the foam are surrounded by multiple air-filled pockets. This configuration contributes to the flammability of the foam: during combustion, the large interfacial area between the urethane struts and the air pockets facilitates oxygen penetration and volatilization of decomposition products, leading to sustained burning. In embodiments, compositions and methods are disclosed herein where the urethane/air interface is chemically converted into an inorganic-material-dominated state during foam formation. Disclosed herein, in embodiments, are polyurethane foams formed with significantly high levels of inorganic materials.

According to certain methods of manufacture, urethane foams are made by rapid and intimate mixing of urethane precursors and water. It would be understood by artisans having ordinary skill in the art that polyurethane foams can be made, for example, by processes as described in U.S. Pat. No. 5,721,281, the contents of which are incorporated herein by reference. It would be further understood by artisans having ordinary skill in the art that a conventional nanoparticle-loaded polyurethane composite can be made, for example, by a process as described in U.S. Pat. No. 7,592,387, the contents of which are incorporated herein by reference.

In embodiments, urethane foam systems and methods for producing them are disclosed herein, wherein the water component of the conventional foam-forming process is replaced with a stable aqueous dispersion of small inorganic particles, for example, clay, calcium carbonate, dolomite, calcium sulfate, kaolin, talc, titanium dioxide, sand, diatomaceous earth, aluminum hydroxide, silica, other metal oxides, fly ash, and any mixture of such materials. Suitable clay materials can include natural or synthetic materials (e.g., Laponite) comprising clay platelets. Examples of suitable clay materials can include smectite (e.g., montmorillonite, saponite, beidellite, nontrite and hectorite clays), vermiculite and halloysite clays. For use in these systems and methods, exfoliated clay platelets or other dispersed inorganic particles can be optionally surface-modified, e.g., by a thin layer of a polymer, a surfactant, etc. Such surface modification can promote the concentration of the dispersed particles at the wall-air interface of the expanded foam during foam formation, and can impart other desirable properties. As utilized throughout the present application, it is understood that embodiments utilizing clay particles or platelets can be implemented with other appropriate inorganic particles and materials, or mixtures of such materials, as would be understood by one skilled in the art.

Resulting foam morphology can be described as an open or closed cell foam, or a mixture of cell types, having walls or struts heavily covered with inorganic matter, e.g., clay platelets. In embodiments, the walls or struts of the foam would be covered by a mosaic of inorganic “tiles,” with few gaps in between. This inorganic coating on the polyurethane/air interface effectively inhibits combustion.

In embodiments, exfoliated clay can be used to provide the inorganic coating for the foam struts. In embodiments, exfoliated clay can be dispersed as a stable aqueous suspension or mixture (e.g., the particulates not tending to flocculate or aggregate with one another) suitable for use in these systems and methods. A number of processes are familiar to skilled artisans for exfoliating clay for dispersion in stable aqueous suspensions. For example, various combinations of strong base, high temperature and vigorous agitation of clays in an aqueous medium can lead to clay exfoliation. As another example, extracting calcium ions from a clay stack can trigger exfoliation; the use of certain chemical agents to bind calcium ions can thus produce exfoliation.

In embodiments, one or more coupling agents can be utilized to aid binding between inorganic materials and the struts of a polymeric foam. A coupling agent is a molecular entity distinct from the strut and inorganic material that acts to couple the strut of a polymeric foam to an inorganic material, either through direct interaction with the surface of the inorganic material and/or strut, and/or acting as an intermediary to induce such coupling (e.g., binding to another entity which ultimately binds to the strut and/or inorganic material). For instance, modifications of inorganic materials can be carried out, with such modified inorganic materials being used to form the stable aqueous suspension of inorganic particles. As an example, clays can be modified in a number of ways for use in accordance with the compositions and methods disclosed herein. As an example, a thin layer of chitosan can be self-assembled on the clay, dispersing the clay in water. If this aqueous solution of chitosan-bearing clay is used as the water component for foam formation, the chitosan can attach the clay to the isocyanate group in the polyurethane forming an urea linkage.

In other embodiments, clay particles can be exfoliated in the presence of a small amount of a bifunctional polyol that contains a hydroxyl group and a primary/secondary/tertiary/quaternary amine group (herein a “polyol amine”). For example, the hydroxyl group can be on one end of the molecule and the amine can be on an opposite end. In embodiments, the positively-charged amine can preferentially bind to the clay nanoparticle surface, leaving the hydroxyl group to participate in the isocyanate part of the urethane foam formation reaction.

In embodiments, the strength of the clay/polyurethane interface can be enhanced by the use of an appropriate surface modification for the clay particles. For instance, a polyamine compound, e.g., chitosan, polyvinylamine or polyethyleneimine, can be adhered to the surface of the clay particle with an amine group binding to the foam wall. Polyamines include polymers having a one or more amine groups in a repeat unit. Desirably, the use of these modifications can ensure that clay particles are durably bound to foam walls even under impact and mechanical perturbation. The impact-resistant binding of the clay particles to the foam struts could be used in situations where the foam would be subjected to mechanical stress, vibration, acceleration/deceleration, collisions, etc. (e.g., insulation in vehicles, machinery, and the like).

In embodiments, exfoliated clay platelets can have on their surface polymeric polyamines or polyol amines which exhibit hydrophobic properties such that the clay platelets are rendered hydrophobic (herein collectively known as “hydrophobic amine modifiers”). For instance, the hydrophobic amine modifiers can include functionalities with hydrophobic moities, for example, polyethyleneimines, polyvinyl amines, or chitosan-like polyamines that have hydrophobic functional groups like alkyl extensions, for example, alkyl tails such as an alkyl group with 3 to 20 carbon atoms. In some embodiments, these hydrophobic amine modifiers can exhibit such hydrophobic properties during the step of polymerization of a polyurethane polymer. For example, a polymer in an aqueous medium can be pH adjusted or temperature adjusted to precipitate out on inorganic surfaces, rendering the polymer hydrophobic-like while such polymer-deposited inorganic particles participate in a polyurethane polymerization reaction.

While not being bound by any particular theory, modification of the inorganic particles (e.g., clay platelets) can affect the viscosity of the platelet suspension, facilitating use of the aqueous suspension in foam manufacture. For instance, it is envisioned that the hydrophobicity of this coating allows the functionalized particles to be directed to the air polyurethane interface, both on the air side of the interface and on the polyurethane side, if any platelets are entrapped within the polyurethane formulation.

In embodiments, a high concentration of inorganic material is desirable, configured so that it is deposited at the air-polyurethane interface along the struts of the foam material. In such embodiments, a high inorganic level of over about 40% by weight (e.g., about 80 to about 90% by weight) can be designed, with the polyurethane acting as an organic “glue” attaching the inorganic material to the foam structural template. In embodiments, a polymeric polyamine hydrophobic coating can fully envelop the platelets, rendering both their edges and their faces hydrophobic.

In embodiments, amine modifiers for inorganic particles, which can optionally be hydrophobic amine modifiers, include residual free amines when the modifier is on a particle surface. Such free amines are available for further condensation reactions with isocyanate to produce bonds with the polyurethane. The residual free amines in the amine modifier disposed on the clay platelets, for example, thus can bond the clay into the foamed polyurethane network. In embodiments, amine modifiers used for inorganic particles can be the only agent for modifying an inorganic surface (e.g., no other coupling agent is utilized).

Without being bound by theory, then, it is envisioned that two factors cooperate to create a durable attachment of the clay platelets to the urethane struts: the hydrophobicity of the coated platelets that urges them towards the air-polyurethane interfaces, and the bonding capability of the free amines in the polymeric coating that attaches the platelets to the polyurethane network. These mechanisms make it unnecessary to use an additional coupling agent to bind the platelets to the polyurethane.

Further, not to be bound by theory, it is envisioned that the hydrophobically coated clay platelets initially arrange themselves randomly within the mixture, but that they respond to shearing (for example, by stirring, etc.) by arranging themselves in stacks, decreasing the viscosity of the mixture. When the mixture containing the hydrophobically-coated clay is added to the isocyanate, this arrangement of clay platelets is disrupted by the foaming process. It is envisioned that the free amines in the coating interact with the isocyanate during the foaming process, resulting in the alignment of the coated clay platelets around the bubbles formed in the polyurethane foam. Hence, it is envisioned that the coated platelets come to be disposed durably at the air-polyurethane interface, coating the polyurethane struts and “plating” the cells of the foam.

In embodiments, the coated clay platelets can predominate as a reaction component in the polyurethane reaction. In embodiments, the ratio of water can be altered in the reaction while still allowing for a predominance of coated clay platelets. In embodiments, other solutes (e.g., alcohols) can be used to suspend the clay platelets so that the foaming reaction characteristics and rates can be modified. In embodiments, the amount of a diol in the reaction can be varied to allow for an increasing availability of free amines from the clay platelet coating.

In embodiments, the systems and methods disclosed herein can improve the use of water as a blowing agent in polyurethane foam formation by use of suspended inorganic particulate matter (e.g., exfoliated clay platelets) in the water, so that the inorganic materials are deposited on the walls of the foam during foam formation. This provides an additional additive of improving the strength and/or rigidity of the foam, while also producing fire retardancy.

It is understood in the art that the amount of water in the polyurethane-producing reaction mixture controls the density and rigidity of the foam, so that the higher the water amount, the less rigid the foam will be. Using suspended inorganic particulate matter (e.g., exfoliated clay platelets) in the blowing agent can improve the physical properties of the resultant foam. For example, an aqueous suspension of exfoliated clay platelets is more viscous, so that more water can be used to produce the same reaction formulation consistency. Moreover, the use of exfoliated clay can hinder the migration of water into the reaction mixture (as clay strongly associates with the water), so that more precise control may need to be exerted over the rate of foam formation. In embodiments, as the foam is formed by the reaction with water with isocyanate (i.e., forming the unstable carbamate leading to the release of CO₂), controlling the availability of water as a reactive species can then enable control over the rate of foam formation and its resulting properties.

In embodiments, control over foam formation kinetics by using an aqueous suspension of an inorganic particulate (e.g., exfoliated clay) can complement the structural features of the foam attributable to the incorporation of the inorganic particulate at the foam/air interface. In embodiments, depositing a high amount of inorganic material (e.g., clay) onto the walls of the foam by using a higher amount of water as a blowing agent can offset the loss of strength and/or rigidity that can occur if a similar amount of water would be used without clay.

In embodiments, the concentration of inorganic materials in the stable aqueous suspension (e.g., the water-exfoliated clay mixture) used for polyurethane foam formation can be increased so that there is a substantial amount of inorganic material in the final foam product. In embodiments, the foam product can comprise between about 10 to about 40% inorganic material. In embodiments, higher concentrations of inorganic material can be obtained, such as greater than about 40%, about 50%, about 60%, or about 70%, and/or up to about 80% to about 90% inorganic material. In embodiments, the concentration of the inorganic material can vary depending on the hydrophilicity of the material, with more hydrophilic materials having a tendency to attract water and thereby increase the viscosity of an aqueous suspension containing them. These more viscous suspensions support only a lower concentration of inorganic material, while more hydrophobic preparations of platelets permit a higher concentration of inorganic material at similar or lower viscosities. In embodiments, higher concentrations of inorganic material can impart other desirable properties besides fire-retardancy, e.g., cost savings and structural stability.

In certain embodiments, the water-inorganic composition can be used to construct a foam wherein the inorganic material predominates. In such embodiments, there can be about 30 to about 45% organic material, or more. Advantageously, such a foam would be mainly inorganic, with the polyurethane acting as a binder. In embodiments, these systems and methods can therefore be used to form a highly inorganic network of inorganic-reinforced foam walls, e.g., clay-reinforced foam walls. In another embodiments, such a foam network can be used as a pre-impregnated structure, where organic fibers or particles are impregnated with a curable organic polymer or monomer and placed in an oven to cure them. In embodiments, such a foam network can be used for the formation of completely inorganic foams: using the inorganic-laden foam network as a template, the inorganic-polyurethane composite could be subjected to high temperatures in an oven so that all organic binder would be removed and the inorganic coating on the struts would fuse into a homogeneous layer that maintains the shape of the polyurethane struts that had been underlying it.

Other inorganic materials can be used in a similar manner, for example, fly ash or colloidal silica, where the inorganic materials are suspended in water used for foam expansion. In other embodiments, the water used for foam expansion can be a saturated or supersaturated metal oxide or salt solution (e.g., bicarbonates or carbonates), so that upon drying a layer of the inorganic deposit resides in a concentrated form at the interface between the foam struts and the air pockets. In embodiments, the inorganic layer on the foam strut may comprise organic inclusions or other organic materials. However, the combustion behavior of this organic/inorganic admixture is still governed by the flame-retardancy of the inorganic component, so that oxidation of the organic materials is inhibited or controlled.

In embodiments, the systems and methods disclosed herein can be used to prepare polyurethane foam for a number of applications. Insulation for buildings can be made entirely from polyurethane foam, or insulation compositions can be formed comprising the polyurethane foam produced in accordance with these systems and methods. As other examples, polyurethane foam produced in accordance with these systems and methods can be used as a blow-in product, or as a product to be injected into molds. In other applications, polyurethane foam in accordance with these systems and methods can be used to form composite or laminate products, for example, prefabricated products where a sheet of foam is covered by another material, e.g., a veneer. A foam-containing composite or laminate can be used for roofing tiles, counter tops, siding, etc.

Any number of prefabricated laminated products can be envisioned where the core is flame-resistant and the surface layer provides desirable properties. For example, the surface layer can be a plastic or a wood layer, or metallic, or stone or composite. The surface layer or layers (e.g., top layer and bottom layer) can be of any thickness depending upon the properties desired in the final composite product. Mechanically durable laminated products can be formed where the foam is covered with or interspersed with other materials layered to provide structural stability. Layers in the laminated product can be formed from different materials, each selected to provide certain properties. For example, an insulated wallboard product can contain a structural central layer of wood, surrounded by two layers of foam insulation fabricated in accordance with these systems and methods, which foam layers are then covered with a decorative thin veneer of wood or plaster. Other laminate combinations comprising flame-retardant foam insulation can be envisioned by practitioners of ordinary skill in the art.

Furthermore, using the modification strategies described herein, the polyurethane foam product can be formulated to possess other advantageous properties, for example, insect repellency or bacteriostatic capacity. For foam products having hydrophobic properties (e.g., by incorporating hydrophobically modified inorganic particles in accordance with these systems and methods), the hydrophobicity can be exploited in products where poor water absorption would be desirable, as in high humidity situations, electronic packaging, etc.

### EXAMPLES

Materials

Aminated polymers made with ethyleneoxide or propyleneoxide monomers XTJ500, XTJ501, XTJ502, XTJ506, D2000, and T3000 (Huntsman Chemicals, The Woodlands, Tex.)

Chitsan cg800, Primex, Siglufjodur, Iceland

Lupamin 9095, BASF Corporation, Florham Park, N.J.

### Example 1

### Preparation of Polyurethane Foam

To form an urethane foam, a urethane linkage is produced by reacting an isocyanate group —N═C═O with a hydroxyl group. Polyurethanes are produced by the polyaddition reaction of a polyisocyanate with a polyalcohol (polyol) in the presence of a catalyst and other additives. The reaction product is a polymer containing the urethane linkage —RNHCOOR′—. Isocyanates react with water to form a urea linkage and CO₂. They react with polyetheramines and polyamines to form polyureas. Commercially, polyurethanes are produced by reacting a liquid isocyanate with a liquid blend of polyols, catalyst and other additives. The release of CO₂ during polymerization can be exploited to form foams. A typical reaction mixture contains polyol (100 parts by weight), isocyanate (60 parts by weight) and water (5 parts by weight), with other additives in smaller quantities.

### Example 2

### Exfoliation of Clay

1% fully neutralized Na₂H₂PO₄.2H₂O was used to extract Ca++ ions from clay. The intercalated clay layers are bound by Ca++ ions, and removal of these by phosphate treatment helps in exfoliation of the clay particles. The clay suspension was made in 1% fully neutralized Na₂H₂PO₄.2H₂O, and the suspension was allowed to sit overnight. The resulting cloudy suspension of clay nanoparticles was stable over a period of 2-3 weeks at room temperature.

### Example 3

### Surface Coating of Exfoliated Clay with Polyamines

Exfoliated clay prepared in accordance with Example 2 can be modified with Chitosan using a 1% CG800 chitosan solution to provide a 1% by weight coating. The chitosan solution can be made by dissolving chitosan powder in acidic water and adjusting the pH till chitosan is completely solubilized. If necessary, a solution of 0.1 M NaOH can then be titrated into the exfoliated clay suspension until the pH reached 8.0. Exfoliated clay can also be coated with other polyamines, such as other akyl amines (or diamines) e.g., hexamethylene diamine, jeffamines, etc.

### Example 4

### Surface Coating of Exfoliated Clay with Polyetheramines

Using the phase-change mechanism of polyether solubility in water, polyetheramines such as the Jeffamine (Huntsman) can be used to modify the surface of the clay particles. These modified clay particles in aqueous solution can then be used to coat the struts of a polyurethane foam, by substituting this aqueous solution for the water component of the polyurethane foam formation process. As the isocyanates react with amines to form polyureas, the incorporation of polyetheramines on the surface of clay particles will integrate them through reaction with the walls of the polyurethane foam.

### Example 5

### Surface Coating of Exfoliated Clay with Polyethers

Polyethers, such as polyethyleneoxide or polypropyleneoxide or a copolymer of the two, can be precipitated onto the surface of the clay by changing the temperature of the solution containing exfoliated clay and the polyethers. For polyethers, by changing the concentration of salt in the solution, the temperature at which cloudiness is observed in the polyether solutions can be lowered or increased (cloudiness indicating polymer precipitation) thus facilitating their absorption onto clay surfaces.

In an experiment, different concentration solutions of polyetheramines such as XTJ500, XTJ502 and T3000 at 0.05, 0.1, 1, 5 and 10% were made in water. To these solutions, salt solutions were added to make 0.1M, 0.2M and 0.3M final salt concentration. The polymer-salt solutions were heated to different temperatures to observe the onset of precipitation of the polymer by monitoring cloudy streaks of polymer precipitation from solutions.

### Example 6

### Surface Modification of Chitosan-Coated Clay

Chitosan-coated clay can be modified with alkyl epoxies or alkyl anhydrides like alkyl succinic acid to make the surface hydrophobic yet still keep the clay dispersed with good dispersion stability. The hydrophobicity of the interior of the polyurethane foams can thus be improved by modifying the clay surface with alkyl epoxies or anhydrides such as alkyl succinic anhydride. A monofunctional alkyl epoxy compound such as octyl glycidyl ether can be used to hydrophobically modify the amine terminated clay surface (such as chitosan modified clay). The stoichiometric of the amine groups to alkyl epoxy groups can be controlled to impart different hydrophobicities to the clay surface.

### Example 7

### Polyamine Modification of Clay Platelet Surfaces

Clay particles to be suspended in an aqueous solution can be surface modified with other polyamines (e.g., polyethyleneimine, polyvinylamine, polyallylamine, and the like. To produce such modified particles, an exfoliated clay suspension produced in accordance with Example 2 can be treated with 1% by weight of one of the aforesaid polyamines. The resulting clay surfaces would be modified with primary amines.

### Example 8

### Modifying Clay Platelet Surfaces with Silylating Agents

Exfoliated clay particles can be silanized to provide anhydride, epoxy or amine functionalities by reacting with appropriate silanes. The hydroxyl functionality on the clay surfaces can react with the silane molecules under appropriate conditions to form silanol linkages. In one embodiment, a 1% silane solution can be prepared using aminopropyltrimethoxy silane in anhydrous CHCl₃. An exfoliated clay sample as prepared in Example 2 is transferred into the organic solvent by exchanging of water with CHCl₃. The silane solution is then added to the clay dispersion at 1% by weight of clay. 1% by weight of water is added to catalyze the reaction. The reaction is allowed to proceed for 1 hr, the solvent drained, and the clay suspension is dried in the oven at 60° C. The resulting amine modified clay is then resuspended in water for further use.

In another example, hydrophobic silanes such as octadecyl trichloro silane could be used to hydrophobically modify clay surfaces to make them compatible with the isocyanate part of the polyurethane reactive system.

### Example 9

### Preparation of Foam with Inorganic-Laden Aqueous Suspensions

Using the general reaction set forth in Example 1, we can replace the water component with the stable aqueous suspensions of inorganic material prepared in accordance with any of Examples 3-8. The resultant foam will contain a coating of inorganic material on the polyurethane struts. In accordance with Examples 3-8, the inorganic material can comprise exfoliated clay platelets, which can be surface modified using polyamines, polyetheramines, silanes, etc., as described above. The inorganic particles adhere to the walls of the polyurethane foam when the CO₂ released during the foam forming process (i.e., due to the reaction of water with the isocyanates) pushes the inorganic particles against the walls of the foam that is being formed. Clay-loading in the water can be about 20 to about 30% or higher, depending on the type of clay. Some clays are water-absorbent (e.g., bentonite), so their loading would be limited by their water uptake. Other types of clay such as the kaolins could be dispersed in water at a high solids content, as much as about 50%.

### Example 10

### Hydrophobically Modified Clay as a Filler in the Polyurethane Reactive System

Hydrophobically modified clay prepared in accordance with Examples 6, 7 or 8 can be used as a filler in the isocyanate part of the reactive system. The presence of modified clay in both the polyol and the polyisocyanate parts of the system helps in distributing the clay along the expanding walls of the foam cells. Hydrophobically modified clay has less water uptake, thereby making it easier to make suspensions with higher clay concentrations.

### Example 11

### Use of other Modified Particles to Produce Fire-Retardant Foams

Other inorganic or organic particles can be modified and used in accordance with these systems and methods to produce flame-resistant and/or fire-retardant polyurethane foams. Inorganic materials can include clay, calcium carbonate, dolomite, calcium sulfate, kaolin, talc, titanium dioxide, sand, diatomaceous earth, aluminum hydroxide, silica, other metal oxides, fly ash, and the like. Organic materials can be used if they impart fire-retardancy (e.g., lignin). To produce a polyurethane foam using one or more these materials, a stable aqueous suspension is created that contains the desired material(s). The stable aqueous suspension is then used to replace the water component of the polyurethane foam-forming system as set forth in Example 1. As another example, a hydrophobic material like lignin could be dispersed either in the isocyanate or the polyol phase, or in water in the polyol phase. The inorganic or organic particles (e.g., lignin) could be surface-modified using polyamines, polyetheramines or silanes as described in the preceding Examples.

### Example 12

### Polyurethane Foam Products

Polyurethane foam prepared in accordance with Examples 10 or 11 can be used to prepare products with fire-resistant cores and with skins (surfaces) comprising various materials. As an example, the polyurethane reaction mixture can be poured into a mold having as one of its walls a metallic or plastic sheet that will form the face of the laminate. The reaction mixture can then be sandwiched in another layer, forming the bottom of the laminate.

### Equivalents

While specific embodiments of the subject invention have been discussed, the above specification is illustrative and not restrictive. Many variations of the invention will become apparent to those skilled in the art upon review of this specification. The full scope of the invention should be determined by reference to the claims, along with their full scope of equivalents, and the specification, along with such variations.

Unless otherwise indicated, all numbers expressing quantities of ingredients, reaction conditions, and so forth used in the specification and claims are to be understood as being modified in all instances by the term “about.” Accordingly, unless indicated to the contrary, the numerical parameters set forth in this specification and attached claims are approximations that may vary depending upon the desired properties sought to be obtained by the present invention.

While this invention has been particularly shown and described with references to preferred embodiments thereof, it will be understood by those skilled in the art that various changes in form and details may be made therein without departing from the scope of the invention encompassed by the appended claims.

1. A polymeric foam, comprising:
a plurality of polymeric struts having an air-foam interface, wherein a composition comprising inorganic particulate material is disposed upon the air-foam interface, the inorganic particulate material comprising inorganic particles coated with a hydrophobic amine modifier.

2. The polymeric foam of claim 1, wherein the hydrophobic amine modifier is capable of exhibiting hydrophobic properties during formation of the polymeric foam.

3. The polymeric foam of claim 2, wherein the hydrophobic amine modifier comprises a polyamine having an alkyl extension capable of rendering the modifier hydrophobic during formation of the polymeric foam.

4. The polymeric foam of claim 2, wherein the hydrophobic amine modifier does not include hydroxyl groups.

5. The polymeric foam of claim 1, wherein the polymeric foam comprises closed cells.

6. The polymeric foam of claim 1, wherein the polymeric struts comprise a polyurethane polymer.

7. The polymeric foam of claim 1, wherein the inorganic particulate matter comprises clay platelets.

8. The polymeric foam of claim 1, wherein the inorganic particulate matter comprises greater than about 20% by weight of the polymeric foam.

9. The polymeric foam of claim 1, wherein the hydrophobic amine modifier is a polymeric polyamine or a polyol amine, or a combination thereof.

10. An article of manufacture according to claim 1.

11. The article of manufacture of claim 10, wherein the inorganic particulate matter comprises greater than about 20% by weight of the polymeric foam.

12. The article of manufacture of claim 10, wherein the inorganic particulate matter comprises greater than about 40% by weight of the polymeric foam.

13. A polymeric foam precursor composition comprising an aqueous dispersion of a polymeric foam precursor and inorganic particles coated with a hydrophobic amine modifier.

14. The composition of claim 13, wherein the polymeric foam precursor is a polyurethane foam precursor.

15. The composition of claim 14, wherein the inorganic particles are clay pellets.

16. A method for producing an inorganic-containing polymeric foam, comprising:
providing inorganic particles coated with a hydrophobic amine modifier; and
forming a stable aqueous dispersion of the coated inorganic particles with polymeric foam precursors, thereby producing the inorganic-containing polymeric foam.

17. The method of claim 16, wherein the inorganic-containing foam comprises greater than about 40% inorganic particles be weight.

18. The method of claim 16, wherein the method does not utilize any other coupling agents to bind the inorganic particles to struts of a polymeric foam.

19. The method of claim 16, wherein the step of forming the stable aqueous dispersion comprises the hydrophobic amine modifier tending to act hydrophobically in the stable aqueous dispersion environment.

20. The method of claim 16, wherein the hydrophobic amine modifier drives the coated inorganic particles to an air-foam interface during foam formation.

21. The method of claim 16, wherein the step of forming the stable aqueous dispersion comprises reacting free amines on the coated inorganic particles with at least one polymeric foam precursor.

22. The method of claim 16, wherein the step of forming the stable aqueous dispersion includes adding alcohol to the dispersion to alter a rate of foam formation.

23. The method of claim 16, wherein the polymeric foam precursor is a polyurethane foam precursor.

24. The method of claim 16, wherein the inorganic particles are clay.
